(19) United States
(12) Patent Application Publication
(10) Pub. No.: US 2009/0139972 A1
(43) Pub. Date: Jun. 4, 2009

(54) DOCKING CONNECTOR

(75) Inventors: William Keith Baker, Belfountain (CA); David MacGregor Taylor, Brampton (CA)

Correspondence Address: Pearne & Gordon LLP, 1801 East 9th Street, Suite 1200, Cleveland, OH, 44114-3108, US

(73) Assignee: PSION TEKLOGIX INC., Mississauga (CA)

(21) Appl. No.: 12/255,991

(22) Filed: Oct. 22, 2008

Related U.S. Application Data
(60) Provisional application No. 60/981,988, filed on Oct. 23, 2007.

(51) Int. Cl. H05B 1/00

(52) U.S. Cl. 219/201

(57) ABSTRACT

A heatable electric connector for preventing frosting of an electrical connector of the heatable electric connector is provided. A heating element provides indirect heating or optionally direct heating of the electrical connector. A temperature controller senses an approximate temperature of the electrical connector and compares the connector temperature to a set-point temperature and either turns on or off the heating element thereby ensuring that the electrical connector is of a suitable temperature so that frost does not form and/or accumulate on the connector.

### FIELD OF INVENTION

The invention relates to electrical connectors and specifically to a docking connector.

### BACKGROUND

Portable electronic equipment, such as hand-held computers, are often used in a wide variety of environments and with a wide variety of peripheral equipment. These environments can range from a warehouse to a freezer to the outdoors, and so on. As a result, portable electronic equipment often needs to be able to function at low temperature such as in a freezer warehouse or outdoors during times of low temperature including temperatures below freezing.

Cold temperatures, including those below freezing, can cause frost to develop on hardware within and withon the portable and peripheral equipment including any electrical connections especially, for example, on a docking connector. Frost build-up can prevent an electrical connector from properly connecting to a frosted connector, for example, a docking connector interface. Frost may form when the connector is exposed to a low temperature freezer and then enters an area of high humidity such as is common with, for example, forklifts equipped with a cradle for interfacing to portable electronic equipment. The formation of frost can cause the elements of a connector, for example pogo pins, to freeze in place which, in turn, causes connectivity problems when a hand-held device is removed and then re-installed into a cradle for the device that has the connector on which frost has formed.

A need therefore exists for a device which prevents frost build-up on an electrical connector of an electrical device.

### SUMMARY

The present invention provides for a heatable electric connector for connection with an electrical device. The heatable electric connector can prevent frosting of the compliant electrical contacts of the heatable electric connector. A heating element provides indirect or direct heating of the electrical contacts. A temperature controller senses an approximate temperature of the electrical connector and compares the connector temperature to a set-point temperature and either turns on or off the heating element thereby ensuring that the electrical connector is of a suitable temperature so that frost does not form and/or accumulate on the connector contacts.

One illustrative embodiment provides for a heatable connector for connection with a device, the connector comprising:
an electrical connector;
a heating element for heating the electrical connector;
a temperature sensing element for determining a connector temperature; and
a control device in communication with the heating element for activating the heating element for heating the electrical connector.

Another illustrative embodiment provides for an electronic device comprising a heatable electric connector, the heatable electric connector comprising:
an electrical connector;
a heating element for heating the electrical connector;
a temperature sensing element for determining a connector temperature; and
a control device in communication with the heating element for activating the heating element for heating the electrical connector.

### BRIEF DESCRIPTION OF THE DRAWINGS

FIG. 1 is a schematic circuit diagram showing one illustrative embodiment of a heated connector.

### DETAILED DESCRIPTION

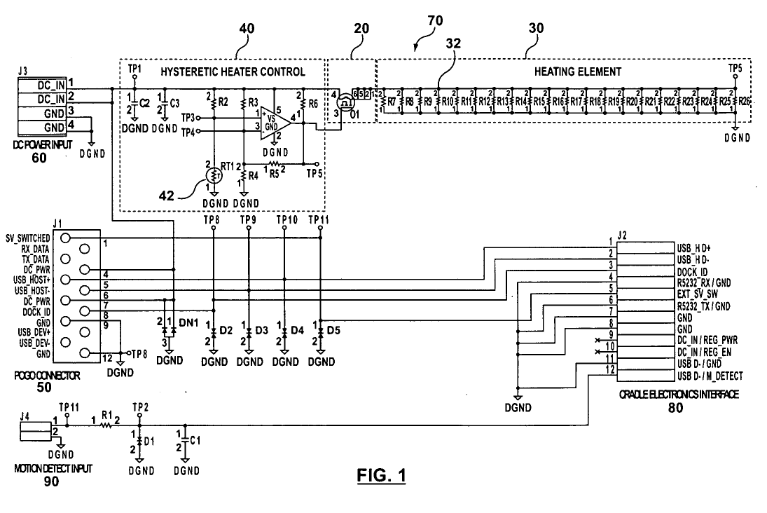

Components forming a heatable electric connector (HEC) which may optionally be implement onto a printed circuit board (PCB) for providing a heatable connector are shown generally in FIG. 1. The HEC 70 has a connector 50 suitable for electric connection with a peripheral or other alternative electronic device having an electric connector suitable for docking with the electric connector 50. The connector 50 may be for example but not limited to a pogo connector, as illustrated in FIG. 1, that may be exposed to environments where frost may form thereon. It will be appreciated that any type of connector may be protected from frost formation by the mechanism disclosed herein and the connector should not be limited to pogo connectors.

For the purposes of this disclosure, the connector includes both electrical connectors and non-electrical connectors such as, but not limited to, fiber optic connectors, fine mechanical connectors, etc.

The HEC 70 also comprises suitable electronics 80 for operating the connector 50 and interfacing with whatever peripheral or other alternative or electronic device may be connected. The HEC 70 may optionally include additional electronics 90, such as motion detect electronics, as illustrated in FIG. 1 in order to realise the requirements of the electronic interface, although these are not elemental components required by the HEC mechanism.

The HEC 70 is intended for use in an electronic device that is exposed to cold environments, such as but not limited to, a freezer or the outdoors and then moves into a condensing (moist) environment such as outside of a freezer or indoors. For example, the HEC 70 may be used in a vehicle mounted cradle on a vehicle which enters a freezer or cooled environment or operates outside during cold periods. As a result, it may be required that the connector 50 connect with an electronic device when being exposed to the cold environment or in a humid environment following exposure to the cold environment. In such a case, frost can develop on the connector 50 preventing connection of the electronic device or requiring the removal of the frost to enable proper connection of the electronic device. To prevent frost formation, the connector 50 is heated. A heating element 30, comprised of one or more resistors 32, is used in the HEC 70 to provide for indirect heating of the connector 50. The heating element 30 may be placed in proximity to the connector 50 to provide indirect heat to the connector 50 when required. A temperature control device 40 may be used to determine the approximate temperature of the HEC 70 and/or the connector 50 and for operating the heating element 30, for example by controlling a switch 20 for allowing power to or preventing power from the heating element 30.

Alternatively, if energy consumption is not a concern or is less of a concern, the temperature control device may be omitted and the heating element 30 may be continuously powered thereby continuously providing indirect heat to the connector 50. In such an implementation, there would be no thermal regulation, and so a thermal cut-off device is required to prevent overheating of the connector mechanism.

Additionally, a temperature control override (not shown) may be included for activating the heating element. The temperature control override may be used by an operator for activating the heating element 30 on demand. This, for example, may be used for preemptively heating the connector 50 in anticipation of exposing the connector 50 to a cold, humid or otherwise undesirable environment to minimize or prevent frost formation on the connector 50.

An ambient temperature sensor (not shown) may also be used to detect the ambient temperature of the environment in which the electronic device is placed to thereby anticipate a possibility of frost forming before the sensor actually cools to a temperature where frost forms. In this embodiment, the ambient temperature sensor measures an ambient temperature near or below a threshold values, for example freezing, and the heating element 30 is switched on to prevent frost from forming on the connector 50.

The temperature control device 40 comprises a temperature sensor such as a thermistor 42, the thermistor 42 being optionally a negative temperature coefficient (NTC) thermistor. The temperature sensor may be placed in close proximity to the connector 50, so the HEC 70 temperature is close to that of the connector 50.

The temperature control device 40 also includes a temperature controller, for example a hysteric temperature controller, for governing the operation of the heater element 30. Non-hysteric control mechanisms could also be used to regulate the connector temperature. Different controllers could be realised to minimise temperature transitions between on and off states of the heater, but these are more complicated. For instance, pulse-width modulation with a PID controller could also do the job and would hold a constant temperature on the connector, but would cost a lot to design and implement.

Alternatively or additionally, the ambient temperature sensor may be in communication with the temperature control device 40 for governing the operation of the heater element 30 based on the ambient temperature. In such a scenario, if the ambient temperature is measured to be below a threshold value, the temperature control device 40 can activate the heater element to provide indirect heating to the connector 50.

Additionally, an electrical connector suitable for docking with the connector 50 may also be a heatable electrical connector as described herein.

An example of the operation of the circuit is as follows:

An LM397 comparator has its non-inverting input biased at the midpoint of the supply rail. An additional feedback resistor between this input and the comparator output provides hysteresis. The inverting input is connected to a resistive divider comprised of the thermistor 42 and a resistor 32 whose value is chosen to match that of the thermistor value at the desired regulation temperature. The output of the comparator is used to drive a P-channel MOSFET that sources current from the power input 60 to the resistors 32 of the heater element 30. It is the temperature of the thermistor 42 that is regulated. The connector 50 and for example the pins of the pogo pins of the connector will tend to be cooler, and therefore the set point temperature should take this into consideration and be made higher than the desired minimum connector or pogo pin temperature.

To increase the amount of heat output, the heating element 30 may contain additional resistors 32 or, alternative, to decrease the amount of heat output, fewer resistors 32 may be incorporated into the HEC 70.

The resistors 32 may be for example 1K 5% 250 mW resistors driven by 15V (net 4.5 W). The resistors 32 may be placed about the connector 50 and may optionally surround the connector 50, or a single electrically insulated resistor of low value may be mechanically attached to the connector housing or tail-ends of the electronic contacts.

In addition to the setup for the temperature control device 40 outlined above, the device 40 may optionally further include a positive temperature coefficient (PTC) thermistor or some other elements as a fail-safe mechanism to prevent over-heating of the connector.

Additionally, another embodiment provides for the inclusion of a thermally conductive material between the heat element 30 and the connector 50 to transfer heat from the heat element 30 to the connector 50. The thermally conductive material should not be electrically conductive and, preferably should be either molded around the heat element 30 and the connector 50 to increase heat transfer or may be malleable and be formed around the heat element 30 and the connector 50. The thermally conductive material may be for example but not limited to epoxy, silicon rubber, etc. One skilled in the art will appreciate that these materials would be specialty materials that are loaded with additional compounds to achieve thermal conductivity. For example, silicon rubber is not very thermally conductive, but silicon rubber loaded with zinc oxide is, e.g. Berquist Sil Pads.

It is within the scope of the invention to use a copper trace embedded around a PCB as the heating element 30. The copper trace in the PCB may be used as an alternative to resistors as outlined above and may be used in large boards or with a very this copper trace to increase the resistance in the trace thereby providing more heat for the connector 50.

### EXAMPLE 1

Topology: Standard comparator circuit with hysterisis. Reference applied to the non-inverting input, measured value on the inverting input. P-Channel Mosfet driven by the comparator output sources current to a bank of resistors forming the heating element.

Measurement by resistive divider with NTC thermistor located as the lower resistor. A PTC thermistor in the upper location may be used for a fail-safe mechanism should the thermistor 42 fail in an open state (a typical failure mode).

Comparator LM397—open collector output, 30V maximum supply voltage

Thermistor: muRata NCPXH103J 10 kΩ@25° C.

Desired regulation temperature: 15° C. (verify by experimentation in application) Nominal thermistor values:

Rₜₕₑᵣₘᵢₛₜₒᵣ(5° C.)=22.0211 kΩ

Rₜₕₑᵣₘᵢₛₜₒᵣ(10° C.)=17.9225 kΩ

Rₜₕₑᵣₘᵢₛₜₒᵣ(15° C.)=14.6735 kΩ

Closest standard resistor value to Rₜₕₑᵣₘᵢₛₜₒᵣ (15° C.)=14.7 kΩ. By linear interpolation the matching temperature would be 15.04° C. A cubic spline or other complex curve fitting may give more accurate or realistic results.

User two 10k0 divider resistors to form a reference voltage and a 10 k pull-up resistor on the open collector comparator output, the amount of hysteresis for a given feedback resistor is as follows:

| Feedback Resistor (kΩ) | Ton (° C.) | Toff (° C.) |
|---|---|---|
| 182 | 13.8 | 16.4 |
| 301 | 14.2 | 15.9 |
| 422 | 14.4 | 15.6 |

Choose Rfeedback as 301 kΩ

Available power: 5 W from 15V=>Minimum R=15²/5=45 Ω

Choose 47Ω 5% resistor for heater element. Such devices are typically wire-wound, so include a clamp diode on any control MOSFET for turn-off transient protection. One can also use 20×1 k 1206 250 mW resistors (provides 152×20/1000=4.5 W) to avoid the mechanical interfacing complexities and manufacturing issues associated with using a leaded power resistor (no protection diode needed in this case).

The range of thermistor values at a given temperature can create a variance of set-point temperature from assembly to assembly. The range of the nominal regulated temperature is calculated below assuming a 14.7 kΩ set-point resistor.

### R_{Thermistor}

| Temperature (° C.) | Low (kΩ) | Nominal (kΩ) | High (kΩ) |
|---|---|---|---|
| 5 | 20.4304 | 22.0211 | 23.6762 |
| 10 | 16.7337 | 17.9255 | 19.1542 |
| 15 | 13.7804 | 14.67.5 | 15.5855 |
| 20 | 11.4116 | 12.0805 | 12.7567 |

Low Bin value:

M=(13.7804−16.7337)/(15−10)=−0.5907

>R_{Thermistor}=−0.5907*T+22.64(kΩ), so if R_{Thermistor}=14.7 kΩ, then T=13.4° C.

High Bin value:

M=(12.7567−15.5855)/(20−15)=−0.5658

>R_{Thermistor}=−0.5658*T+24.072(kΩ), so if R_{Thermistor}=14.7 kΩ, then T=16.6° C.

Therefore, there is a 1.6° C. variance about the nominal set point temperature. If 13.4° C. is too low to prevent frosting of the connector, or the pins of the connector, then the set-point will need to be raised to a higher temperature.

Given the amount of hysteresis and a possible worst case low bin part, the temperature where the heating element is turned on may be as low as 12.6° C.

The present invention has been described with regard to a plurality of illustrative embodiments and examples. However, it will be apparent to persons skilled in the art that a number of variations and modifications can be made without departing from the scope of the invention as defined in the claims.

We claim:

1. A heatable connector for connection with a device, the connector comprising:
an electrical connector;
a heating element for heating the electrical connector;
a temperature sensing element for determining a connector temperature; and
a control device in communication with the heating element for activating the heating element for heating the electrical connector.

2. The connector of claim 1, wherein the control device is in communication with the temperature sensing element, the control device for comparing the connector temperature to a set temperature and cycling the heating element on when the connector temperature is below the set temperature and off when the connector temperature is at or above the set temperature.

3. The connector of claim 1, wherein the heating element comprises one or more resistors.

4. The connector of claim 3, wherein the heating element is one or more 1 K 5% 250 mW resistors driven by 15V (net 4.5 W).

5. The connector of claim 1, wherein the temperature control device comprises a thermistor for sensing the connector temperature selected from the group consisting of an NTC thermistor and a PTC thermistor.

6. The connector of claim 1, wherein the temperature control device comprises a temperature controller for comparing the connector temperature and the set temperature.

7. The connector of claim 6, wherein the temperature controller is selected from the group consisting of a hysteric temperature controller and a non-hysteric temperature controller.

8. The connector of claim 1, further comprising an ambient temperature sensor for measuring an ambient temperature.

9. The connector of claim 1, wherein the heating element is a copper trace embedded in a circuit board around at least a portion of the electrical connector.

10. The connector of claim 1, wherein the electrical connector is selected from the group consisting of: a compliant connector and a non-compliant connector.

11. The connector of claim 1, wherein the electrical connector is a pogo connector.

12. The connector of claim 1, wherein the temperature control device is connected to the heating element by a switch operated by the temperature control device.

13. The connector of claim 1, wherein the temperature control device comprises a power supply for operating the heating element and a switch for enabling power to be sent to the heating element.

14. The connector of claim 1, wherein the electrical connector and the temperature control device are implemented into a printed circuit board.

15. The connector of claim 1, wherein the heating element is mounted directly to the electrical connector and is electrically connected to the controller.

16. The connector of claim 1, wherein the heating element is placed at least substantially around the electrical connector.

17. The connector of claim 1, wherein the temperature sensor is in proximity to the electrical connector for sensing the connector temperature.

18. The connector of claim 1, wherein the temperature sensor is mounted directly to the contacts of the electrical connector.

19. An electronic device comprising a heatable electric connector, the heatable electric connector comprising:
an electrical connector;
a heating element for heating the electrical connector;
a temperature sensing element for determining a connector temperature; and
a control device in communication with the heating element for activating the heating element for heating the electrical connector.

20. The device of claim 19, wherein the control device is in communication with the temperature sensing element, the control device for comparing the connector temperature to a set temperature and cycling the heating element on when the connector temperature is below the set temperature and off when the connector temperature is at or above the set temperature.

21. The device of claim 19, wherein the heating element comprises one or more resistors.

22. The device of claim 19, wherein the heatable electric connector is connected to a printed circuit board, and the heating element comprises a copper trace embedded in the circuit board around at least a portion of the electrical connector.
